(19) United States
(12) Patent Application Publication
(10) Pub. No.: US 2006/0160711 A1
(43) Pub. Date: Jul. 20, 2006

(54) Perfume delivery system

(75) Inventor: Peter Frank, Powell, OH (US)

Correspondence Address: FITCH, EVEN, TABIN & FLANNERY, P. O. BOX 65973, WASHINGTON, DC, 20035, US

(73) Assignee: Goldschmidt Chemical Corporation, Hopewell, VA (US)

(21) Appl. No.: 11/311,657

(22) Filed: Dec. 20, 2005

Related U.S. Application Data
(60) Provisional application No. 60/637,642, filed on Dec. 21, 2004.

(51) Int. Cl. C11D 3/50

(52) U.S. Cl. 510/101

(57) ABSTRACT

Perfume delivery systems, comprising insoluble carrier particles with surface silanols, which have been grafted with an organosilane and which carry organic residues with a positively charged functional group and a fragrance adsorbed to or absorbed into the carrier particles. The perfume delivery systems impart a long lasting fragrance to fabric treated with compositions containing the perfume delivery system.

### CROSS REFERENCE TO RELATED APPLICATIONS

The present application claims priority to and the benefit of US provisional application 60/637,642, filed on Dec. 21, 2004, the contents of which is hereby incorporated by reference in its entirety.

### FIELD OF THE INVENTION

The invention relates to perfume delivery systems comprising insoluble carrier particles with surface silanols, which have been grafted with an organosilane and which carry organic residues with a positively charged functional group and a fragrance adsorbed to or absorbed into the carrier particles. The perfume delivery systems impart a long lasting fragrance to fabric treated with compositions containing the perfume delivery system.

### BACKGROUND OF THE INVENTION

Fabric care products such as detergents or fabric softeners usually contain a perfume which both masks the unpleasant odors of some fabric care products and imparts fabrics treated with a pleasing fragrance. Perfumes are among the most expensive ingredients of fabric care products and therefore it is desirable to have as much of the perfume remain in the treated fabric as possible. This is particularly important for fabric care products which are used for treating fabrics in an aqueous process, such as in laundry detergents or rinse cycle fabric softeners. For these products there is a need for perfume delivery systems that are substantive on fibers, which means they will stick to the fibers during the fabric treatment and will not be lost with a wash liquor or rinse liquor. Such a perfume delivery system should also provide a delayed release of perfume to impart the treated fabric with a long lasting fragrance, starting with a moderate level of fragrance intensity that is not perceived as offensive.

GB 1 306 924 discloses finely divided silica and finely divided silica gel as carrier particles for perfume oils. Using these carrier particles, liquid perfume oils can be formulated as free flowing powders comprising up to 70 wt. % of the perfume oil.

U.S. Pat. No. 5,840,668 discloses perfumed laundry detergent powders. The disclosed detergents contain a perfume on carrier system comprising amorphous silica as the carrier. The experiments described in column 7, line 58 to column 9, line 26 demonstrate that perfume adsorbed onto carrier particles of silica is rapidly released into an aqueous wash liquor in the presence of only small amounts of surfactants. Therefore, such a perfume delivery system will not be efficient in delivering a perfume to a fabric treated with the disclosed detergent.

U.S. Pat. No. 4,954,285 discloses the incorporation of silica particles having a perfume adsorbed thereon into solid dryer-activated fabric softener compositions. The document discloses in column 4, lines 53 to 55 that the perfumed silica particles will release perfume when they are wetted with an aqueous fluid. In accordance with this teaching, the document discloses particles of the fabric softener composition comprising perfumed silica particles having an additional water insoluble coating for the application of the fabric softener in an aqueous process.

U.S. Pat. No. 4,954,285 discloses a perfume containing carrier consisting of particles of a smectite type clay or a zeolite with a perfume absorbed into the particle, having a coating of a fabric adhesive agent, which is preferably a quaternary ammonium compound. The perfume delivery system is used in a laundry detergent and the document discloses an increased level of fragrance for fabrics washed with such a laundry detergent compared to fabrics washed with a laundry detergent containing the perfume without a carrier system. However, the perfume delivery system disclosed in U.S. Pat. No. 4,536,315 still has the drawback that surfactants or dispersants can easily remove the coating of the particles during the process of treating the fabrics, which will diminish the efficiency of perfume delivery.

U.S. Pat. No. 5,476,660 discloses compositions for depositing an active substance, such as a perfume, onto a target surface, such as a fabric, containing carrier particles with a cationic surface, having positively charged organocarbyl groups, and an active substance absorbed or adsorbed by the carrier particles. The carrier particles can be made by coating a solid material like porous silica, zeolite or latex particles with a polymer, which has pendant positively charge groups. An alternative way of making the carrier particles is by grafting a solid material, which has surface reactive groups, with one or more polymers containing difunctional organocarbyl groups. The grafting process disclosed in U.S. Pat. No. 5,476,660 requires difunctional polymers which are not readily available.

Therefore, there is still a need for perfume delivery systems which efficiently direct a perfume to a fabric surface and keep it there by adhering to the fibers and which provides the fabric with a long lasting fragrance. Ideally, such a perfume delivery system should be easy to prepare and should be insensitive to surfactants or dispersants in the sense, that the functional groups directing the perfume delivery system to the fabric fibers should not be removed by a detergent or dispersant. It is an object of the present invention to provide a perfume delivery system having these properties.

### SUMMARY OF THE INVENTION

The present invention relates to a perfume delivery system comprising water insoluble carrier particles having surface silanol groups, wherein at least part of said silanol groups are substituted with organic residues by grafting with at least one organosilane and wherein at least part of the organic residues carry positively charged functional groups, and a fragrance adsorbed to or absorbed into said carrier particles. The invention also provides a process for making a perfume delivery system of the present invention.

In a first embodiment, the process for preparing a perfume delivery system of the present invention comprises the steps:
a) reacting water insoluble carrier particles having surface silanol groups with an organosilane having at least one functional group comprising a basic nitrogen atom to obtain carrier particles, wherein at least part of said silanol groups are substituted with organic residues carrying said functional group;
b) reacting the particles obtained in step a) with an alkylating agent to obtain carrier particles, wherein at least part of said organic residues carry at least one functional group comprising an alkylated nitrogen atom carrying a positive charge; and
c) contacting the particles obtained in step b) with a fragrance to adsorb said fragrance onto said particles or absorb said fragrance into said particles.

In a second embodiment, the process for preparing a perfume delivery system of the present invention comprises the steps:
a) reacting an organosilane having at least one functional group comprising a basic nitrogen atom with an alkylating agent to obtain an organosilane having at least one functional group comprising an alkylated nitrogen atom carrying a positive charge;
b) reacting the product obtained in step a) with insoluble carrier particles having surface silanol groups to obtain carrier particles, wherein at least part of said silanol groups are substituted with organic residues carrying said functional group comprising an alkylated nitrogen atom carrying a positive charge; and
c) contacting the particles obtained in step b) with a fragrance to adsorb said fragrance onto said particles or absorb said fragrance into said particles.

In a third embodiment, the process for preparing a perfume delivery system of the present invention comprises the steps:
a) reacting water insoluble carrier particles having surface silanol groups with an organosilane having at least one functional group comprising a basic nitrogen atom or a hydroxy radical to obtain carrier particles, wherein at least part of said silanol groups are substituted with organic residues carrying said functional group;
b) reacting the particles obtained in step a) with a quaternary ammonium compound comprising an epoxy or chlorohydrin functional group to obtain carrier particles, wherein at least part of said organic residues carry at least one functional group comprising a quaternary ammonium group; and
c) contacting the particles obtained in step b) with a fragrance to adsorb said fragrance onto said particles or absorb said fragrance into said particles.

The invention also provides fabric softening compositions comprising the perfume delivery system of the present invention and one or more fabric softening active quaternary ammonium compounds, as well as laundry detergent compositions, comprising the perfume delivery system of the present invention and one or more surfactants.

### DETAILED DESCRIPTION OF THE INVENTION

A. Carrier Particles

The perfume delivery system of the invention comprises water insoluble carrier particles which initially have surface silanol groups. Such surface silanol groups are hydroxy groups directly bonded to a silicon atom of the carrier particles, which are accessible on the surface and can undergo condensation reactions. The carrier particles may be both inorganic materials or hybrid organic-inorganic polysiloxanes carrying surface silanol groups. Preferably, the carrier particles are inorganic particles selected from silicas, silica gels, silicates or aluminum silicates. The carrier particles of the perfume delivery system of the invention can also be mixtures of these materials. The silicates and aluminum silicates used as carrier particles for the invention preferably contain alkali metal ions or alkali earth metal ions to compensate any extra negative charge of the material. Preferably, negative charges are compensated by sodium ions.

In a preferred embodiment of the invention, the carrier particles are silicas, selected from the group consisting of precipitated silicas, fumed silicas and silica gels. In another preferred embodiment of the invention, the insoluble carrier particles are aluminum silicates with a zeolite structure. Most preferably, the zeolite is a large pore zeolite selected from the group comprising of zeolite X, zeolite Y and dealuminated zeolite Y.

The water insoluble carrier particles preferably have a high specific surface area of more than 30 m²/g and preferably more than 100 m²/g. The carrier particles may be porous particles, such as precipitated silicas, where the specific surface is largely due to the pores of the particles. The water insoluble carrier particles may also be non-porous particles, such as fumed silicas, where the particles are composed of small primary particles having a high geometric outer surface.

The insoluble carrier particles may be small size particles with a particle size in the range of 0.1 to 10 μm. Alternatively, large size particles with a particle size in the range of 10 to 100 μm may be used, which are preferably attained by agglomeration of smaller size particles. Small size carrier particles are preferred, if the perfume delivery system is to be used in a liquid formulation having low viscosity, to avoid settling of the particles. Large size particles are preferred for a convenient handling of the perfume delivery system and to avoid dust formation during the handling.

The surface silanol groups of the insoluble carrier particles are partially or completely substituted with organic residue by a grafting reaction with at least one organosilane. The term organosilane here stands for a silicon compound that carries at least one organic residue bonded to a silicon atom through a silicon-carbon bond and which carries at least one reactive group bonded to silicon that is capable of reacting with a silanol group in a grafting reaction. A grafting reaction is a reaction that forms a covalent Si—O—Si linkage between a silicon atom of the carrier particle and a silicon atom of the organosilane. The grafting reaction leads to a permanent covalent bonding of the organic residue of the organosilane to the surface of the carrier particles.

The organosilanes used for grafting preferably comprise two or three functional groups that are reactive in the grafting reaction, such as chloride, alkoxide or hydroxide bonded to silicon, to enable the formation of multiple linkages between the organosilane and the particle surface in the grafting reaction. Mixtures of two or more organosilanes may be used to obtain the desired composition of organic residue grafted to the carrier particle surface.

At least part of the organic residues grafted to the carrier particle surface carry positively charged functional groups, such as ammonium, phosphonium, sulfonium, amidinium, guanidinium or pyridinium functional groups. Preferably, the positively charged functional groups are functional groups with a permanent positive charge independent of the pH value of the medium surrounding the carrier particle. Most preferably, the positively charged functional groups are quaternary ammonium groups. In a preferred embodiment, each of the organic residues carries at least one positively charged functional group. The organic residues may carry one positively charge group per residue or several positively charged functional groups. The positive charges of the functional groups are conveniently compensated by counterions, such as chloride, bromide, sulfate, phosphate, carbonate, hydrogencarbonate, methylsulfate or the like.

The positively charged functional group may already be included in the organosilane before the organosilane is reacted with the surface silanol groups of the carrier particles in the grafting reaction. In an alternative embodiment, the carrier particles are grafted with an organosilane which carries one or more functional groups that are not charged and which are converted to a positively charged functional group after the silane has been grafted onto the carrier particle surface. An example of this embodiment is a carrier particle, which is first grafted with an organosilane comprising one or more amino groups and which after the grafting reaction is alkylated to convert at least part of the amino groups to quaternary ammonium groups.

The size and the composition of the organic residues grafted onto the surface of the carrier particles may be selected in a wide range, as long as at least part of the organic residues carry a positively charged functional group. Preferably, the organic residues comprise from 2 to 20 carbon atoms.

It is preferred to select the carrier particle and the at least one organosilane in such a manner as to provide, after grafting, a carrier particle that has a hydrophilic surface and therefore will be wetted when in contact with water. Carrier particles with a hydrophilic surface also have the advantage of being easily dispersed in aqueous formulations.

B. Fragrance

The perfume delivery system of the invention further comprises a fragrance adsorbed to or absorbed into the water insoluble carrier particles. The fragrance comprises one or more fragrant compounds and may in addition comprise one or more suitable solvents and further additives, such as antioxidants. The fragrance is applied to the carrier particles in a liquid state, either as such or as a solution in one or more suitable solvents. Application of the fragrance onto the carrier particles may be achieved by any suitable process, such as spraying the fragrance or a fragrance solution onto the carrier particles in a mixer or in a fluidized bed. If the perfume delivery system comprises nonporous carrier particles, the fragrance will be adsorbed to the surface of such carrier particles. If the perfume delivery system comprises porous carrier particles, most of the fragrance will be absorbed into the pores of the carrier particles. The composition of the fragrance and the nature of the fragrant compounds can be selected within a wide range and is not limited, as long as the fragrant compounds are sufficiently stable in contact with the material of the water insoluble carrier particles. If the perfume delivery system is intended to be used in an aqueous formulation or for applications in aqueous systems, the fragrant compounds contained in the fragrance are preferably selected from compounds having a low solubility in water.

Suitable fragrant compounds are for example adoxal (2,6,10-trimethyl-9-undecen-1-al), amyl acetate, amyl salicylate, anisic aldehyde (4-methoxy benzaldehyde), bacdanol (2-ethyl-4-(2,2,3-trimethyl-3-cyclopenten-1-yl)-2-buten-1-ol), benzaldehyde, benzophenone, benzyl acetate, benzyl salicylate, 3-hexen-1-ol, cetalox (dodecahydro-3A,6,6,9A-tetra-methylnaphtho[2,1B]-furan), cis-3-hexenyl acetate, cis-3-hexenyl salicylate, citronellol, coumarin, cyclohexyl salicylate, cymal (2-methyl-3-(4-isopropylphenyl) propionaldehyde), decyl aldehyde, ethyl vanillin, ethyl-2-methyl butyrate, ethylene brassylate, eucalyptol, eugenol, exaltolide (cyclopentadecanolide), florhydral (3-(3-isopropylphenyl)butanal), galaxolide (1,3,4,6,7,8-hexahydro-4,6,6,7,8,8-hexamethylcyclopenta-gamma-2-benzopyrane), gamma-decalactone, gamma-dodecalactone, geraniol, geranyl nitrile, helional (alpha-methyl-3,4-(methylenedioxy)hydrocinnamaldehyde), heliotropin, hexyl acetate, hexyl cinnamic aldehyde, hexyl salicylate, hydroxyambran (2-cyclododecyl-propanol), hydroxycitronellal, iso E super (7-acetyl-1,2,3,4,5,6,7,8-octahydro-1,1,6,7,tetramethylnaphthalene), iso-eugenol, iso-jasmone, koavone (acetyl di-isoamylene), lauric aldehyde, lrg 201 (2,4-dihydroxy-3,6-dimethyl benzoic acid methyl ester), lyral (4-(4-hydroxy-4-methyl-pentyl)-3-cylcohexene-1-carboxaldehyde), majantol (2,2-dimethyl-3-(3-methy-lphenyl)-propanol), mayol (4-(1-methylethyl)cyclohexane methanol), methyl anthranilate, methyl beta-naphthyl ketone, methyl cedrylone (methyl cedrenyl ketone), methyl chavicol (1-methyloxy-4,2-propen-1-yl benzene), methyl dihydrojasmonate, methyl nonyl acetaldehyde, musk indanone (4-acetyl-6-tert-butyl-1,1-dimethylindane), nerol, nonalactone (4-hydroxynonanoic acid lactone), norlimbanol (1-(2,2,6-trimethyl-cyclohexyl)-3-hexanol), P. T. bucinal (2-methyl-3(4-tert-butylphenyl) propionaldehyde), para-hydroxyphenylbuta-none, patchouli, phenyl acetaldehyde, phenyl ethyl acetate, phenyl ethyl alcohol, phenyl ethyl phenyl acetate, phenyl hexanol/phenoxanol (3-methyl-5-phenylpentanol), polysantol (3,3-dimethyl-5-(2,2,3-trimethyl-3-cyclopenten-1-yl)-4-penten-2-ol), rosaphen (2-methyl-5-phenyl-pentanol), sandalwood, alpha-terpinene, tonalid/musk plus (7-acetyl-1,1,3,4,4,6-hexamethyltetralin), undecalactone, undecavertol (4-methyl-3-decen-5-ol), undecyl aldehyde, undecenylic aldehyde, vanillin, allyl amyl glycolate, allyl anthranilate, allyl benzoate, allyl butyrate, allyl caprate, allyl caproate, allyl cinnamate, allyl cyclohexane acetate, allyl cyclohexane butyrate, allyl cyclohexane propionate, allyl heptoate, allyl nonanoate, allyl salicylate, amyl cinnamyl acetate, amyl cinnamyl formate, cinnamyl formate, cinnamyl acetate, cyclogalbanate, geranyl acetate, geranyl acetoacetate, geranyl benzoate, geranyl cinnamate, methallyl butyrate, methallyl caproate, neryl acetate, neryl butyrate, amyl cinnamyl formate, alpha-methyl cinnamyl acetate, methyl geranyl tiglate, mertenyl acetate, farnesyl acetate, fenchyl acetate, geranyl anthranilate, geranyl butyrate, geranyl iso-butyrate, geranyl caproate, geranyl caprylate, geranyl ethyl carbonate, geranyl formate, geranyl furoate, geranyl heptoate, geranyl methoxy acetate, geranyl pelargonate, geranyl phenylacetate, geranyl phthalate, geranyl propionate, geranyl iso-propoxyacetate, geranyl valerate, geranyl iso-valerate, trans-2-hexenyl acetate, trans-2-hexenyl butyrate, trans-2-hexenyl caproate, trans-2-hexenyl phenylacetate, trans-2-hexenyl propionate, trans-2-hexenyl tiglate, trans-2-hexenyl valerate, beta-pentenyl acetate, alpha-phenyl allyl acetate, prenyl acetate, trichloromethylphenylcarbinyl acetate, secondary-n-amyl acetate, ortho-tertiary-amyl-cyclohexyl acetate, isoamyl benzyl acetate, sec-n-amyl butyrate, amyl vinyl carbinyl acetate, amyl vinyl carbinyl propionate, cyclohexyl salicylate, dihydro-nor-cyclopentadienyl acetate, dihydro-nor-cyclopentadienyl propionate, isobomyl acetate, isobornyl salicylate, isobornyl valerate, flor acetate, frutene, 2-methylbuten-2-ol-4-acetate, methyl phenyl carbinyl acetate, 2-methyl-3-phenyl propan-2-yl acetate, prenyl acetate, 4-tert-butyl cyclohexyl acetate, verdox (2-tert-butyl cyclohexyl acetate), vertenex, (4-tert-butylcyclohexyl acetate), Violiff (carbonic acid 4-cycloocten-1-yl methyl ester), ethenyl-iso-amyl carbinylacetate, fenchyl acetate, fenchyl benzoate, fenchyl-n-butyrate, fenchyl isobutyrate, laevo-menthyl acetate, dl-menthyl acetate, menthyl anthranilate, menthyl benzoate, menthyl-iso-butyrate, menthyl formate, laevo-menthyl phenylacetate, menthyl propionate, menthyl salicylate, menthyl-iso-valerate, cyclohexyl acetate, cyclohexyl anthranilate, cyclohexyl benzoate, cyclohexyl butyrate, cyclohexyl-iso-butyrate, cyclohexyl caproate, cyclohexyl cinnamate, cyclohexyl formate, cyclohexyl heptoate, cyclohexyl oxalate, cyclohexyl pelargonate, cyclohexyl phenylacetate, cyclohexyl propionate, cyclohexyl thioglycolate, cyclohexyl valerate, cyclohexyl-iso-valerate, methyl amylacetate, methyl benzyl carbinyl acetate, methyl butyl cyclohexanyl acetate, 5-methyl-3-butyl-tetrahydropyran-4-yl acetate, methyl citrate, methyl-iso-campholate, 2-methyl cyclohexyl acetate, 4-methyl cyclohexyl acetate, 4-methyl cyclohexyl methyl carbinyl acetate, methyl ethyl benzyl carbinyl acetate, 2-methylheptanol-6-acetate, methyl heptenyl acetate, alpha-methyl-n-hexyl carbinyl formate, methyl-2-methylbutyrate, methyl nonyl carbinyl acetate, methyl phenyl carbinyl acetate, methyl phenyl carbinyl anthranilate, methyl phenyl carbinyl benzoate, methyl phenyl carbinyl-n-butyrate, methyl phenyl carbinyl-iso-butyrate, methyl phenyl carbinyl caproate, methyl phenyl carbinyl caprylate, methyl phenyl carbinyl cinnamate, methyl phenyl carbinyl formate, methyl phenyl carbinyl phenylacetate, methyl phenyl carbinyl propionate, methyl phenyl carbinyl salicylate, methyl phenyl carbinyl-iso-valerate, 3-nonyl acetate, 3-nonenyl acetate, nonane diol-2,3-acetate, nonynol acetate, 2-octyl acetate, 3-octyl acetate, n-octyl acetate, secondary-octyl-iso-butyrate, beta-pentenyl acetate, alpha-phenyl allyl acetate, phenylethyl methyl carbinyl-iso-valerate, phenylethyleneglycol diphenylacetate, phenylethyl ethnyl carbinyl acetate, phenylglycol diacetate, seconday-phenylglycol monoacetate, phenylglycol monobenzoate, isopropyl caprate, isopropyl caproate, ispropyl caprylate, isopropyl cinnamate, para-isopropyl cyclohexyl acetate, propylglycol diacetate, propyleneglycol di-isobutyrate, propyleneglycol dipropionate, isopropyl-n-heptoate, isopropyl-n-hept-1-yne carbonate, isopropyl pelargonate, isopropyl propionate, isopropyl undecylenate, isopropyl-n-valerate, isopropyl-n-valerate, isopropyl-iso-valerate, isopropyl sebacinate, isopulegyl acetate, isopulegyl acetoacetate, isopulegyl isobutyrate, isopulegyl formate, thymyl propionate, alpha-2,4-trimethyl cyclohexane methylacetate, trimethyl cyclohexyl acetate, vanillin triacetate, vanillylidene diacetate, vanillyl vanillate, tert-amyl acetate, caryophyllene acetate, cedrenyl acetate, cedryl acetate, dihydromyrcenyl acetate, dihydroterpinyl acetate, dimethyl benzyl carbinyl acetate, dimethyl benzyl carbinyl isobutyrate, dimethyl heptenyl acetate, dimethyl heptenyl formate, dimethyl heptenyl propionate, dimethyl heptenyl-iso-butyrate, dimethyl phenylethyl carbinyl acetate, dimethyl phenylethyl carbinyl-iso-butyrate, dimethyl phenylethyl carbinyl-iso-valerate, dihydro-nor-dicyclopentadienyl acetate, dimethyl benzyl carbinyl butyrate, dimethyl benzyl carbinyl formate, dimethyl benzyl carbinyl propionate, dimethyl phenylethyl carbinyl-n-butyrate, dimethyl phenylethyl carbinyl formate, dimethyl phenylethyl carbinyl propionate, elemyl acetate, ethinyl cyclohexylacetate, eudesmyl acetate, eugenyl cinnamate, eugenyl formate, iso-eugenyl formate, eugenyl phenylacetate, iso-eugenyl phenylacetate, guaiyl acetate, hydroxycitronellyl ethylcarbonate, linallyl acetate, linallyl anthranilate, linallyl benzoate, linallyl butyrate, linallyl iosbutyrate, linallyl carproate, linallyl caprylate, linallyl cinnamate, linallyl citronellate, linallyl formate, linallyl heptoate, linallyl-N-methylanthranilate, linallyl methyltiglate, linallyl pelargonate, linallyl phenylacetate, linallyl propionate, linallyl pyruvate, linallyl salicylate, linallyl-n-valerate, linallyl-iso-valerate, methylcyclopentenolone butyrate, methyl cyclopentenolone propionate, methyl ethyl phenyl carbinyl acetate, methyl heptinyl carbonate, methyl nicotinate, myrcenyl acetate, myrcenyl-formate, myrcenyl propionate, cis-ocimenyl acetate, phenyl salicylate, terpinyl acetate, terpinyl anthranilate, terpinyl benzoate, terpinyl-n-butyrate, terpinyl-iso-butyrate, terpinyl cinnamate, terpinyl formate, terpinyl phenylacetate, terpinyl propionate, terpinyl-n-valerate, terpinyl-iso-valerate, tributyl acetylcitrate, amyl vinyl carbinyl acetate, amyl vinyl carbinyl propionate, hexyl vinyl carbinyl acetate, 3-nonenyl acetate, 4-hydroxy-2-hexenyl acetate, linallyl anthranilate, linallyl benzoate, linallyl butyrate, linallyl iso-butyrate, linallyl carproate, linallyl caprylate, linallyl cinnamate, linallyl citronellate, linallyl formate, linallyl heptoate, linallyl-N-methylanthranilate, linallyl methyltiglate, linallyl pelargonate, linallyl phenylacetate, linallyl propionate, linallyl pyruvate, linallyl salicylate, linallyl-n-valerate, linallyl-iso-valerate, myrtenyl acetate, nerolidyl acetate, nerolidyl butyrate, beta-pentenyl acetate, alpha-phenyl allyl acetate, acetylfuran, allethrolone, allyl-ionone, allyl-pulegone, amyl-cyclopentenone, benzylideneacetone, benzylideneacetophenone, alpha-iso-methyl-ionone, 4-(2,6,6-trimetyl-1-cyclohexen-1-yl)-3-buten-2-one, beta-damascone (1-(2,6,6-trimethyl-cyclohexen-1-yl)-2-buten-1-one), damascenone (1-(2,6,6-trimethyl-1,3-cyclohexadien-1-yl)-2-buten-1-one), delta-damascone (1-(2,6,6-trimethyl-3-cyclo-hexen-1-yl)-2-buten-1-one), alpha-ionone (4-(2,6,6-trimethyl-1-cyclohexenyl-1-yl)-3-buten-2-one), beta-ionone (4-(2,6,6-trimethyl-1-cyclohexen-1-yl)-3-butene-2-one), gamma-methylionone (4-(2,6,6-trimethyl-2-cyclohexyl-1-yl)-3-methyl-3-buten-2-one), pulegone, acetaldehyde benzyl-beta-methoxyethylacetal, acetaldehyde di-iso-amylacetal, acetaldehyde di-pentanediolacetal, acetaldehyde di-n-propylacetal, acetaldehyde ethyl-trans-3-hexenylacetal, acetaldehyde phenylethyleneglycolacetal, acetaldehydephenylethyl n-propylacetal, cinnamic aldehyde dimethylacetal, acetaldehyde benzyl-beta-methoxyethylacetal, acetaldehyde di-iso-amylacetal, acetaldehyde diethylacetal, acetaldehyde di-cis-3-hexenylacetal, acetaldehyde di-pentanediolacetal, acetaldehyde di-n-propylacetal, acetaldehyde ethyl-trans-3-hexenylacetal, acetaldehyde phenylethyleneglycolacetal, acetaldehyde phenylethyl-n-propylacetal, acetylvanillin dimethylacetal, alpha-amylcinnamic aldehyde di-iso-propylacetal, p-tert-amylphenoxyacetaldehyde diethylacetal, anisaldehyde diethylacetal, anisaldehyde dimethylacetal, iso-apiole, benzaldehyde diethylacetal, benzaldehyde di-(ethyleneglycolmonobutylether)acetal, benzaldehyde dimethylacetal, benzaldehyde ethyleneglycolacetal, benzaldehyde glycerylacetal, benzaldehyde propyleneglycolacetal, cinnamic aldehyde diethylacetal, citral diethylacetal, citral dimethylacetal, citral propyleneglycolacetal, alpha-methylcinnamic aldehyde diethylacetal, alpha-cinnamic aldehyde dimethylacetal, phenylacetaldehyde 2,3-butyleneglycolacetal, phenylacetaldehyde citronellyl-methylacetal, phenylacetaldehyde diallylacetal, phenylacetaldehyde diamylacetal, phenylacetaldehyde dibenzylacetal, phenylacetaldehyde dibutylacetal, phenylacetaldehyde diethylacetal, phenylacetaldehyde digeranylacetal, phenylacetaldehyde dimethylacetal, phenylacetaldehyde ethyleneglycolacetal, phenylacetalde glycerylacetal, citronellal cyclomonoglycolacetal, citronellal diethylacetal, citronellal dimethylacetal, citronellal diphenylethylacetal, geranoxyacetaldehyde diethylacetal, acetone diethylketal, acetone dimethylketal, acetophenone diethylketal, methyl-amyl-catechol ketal, methyl-butyl-catechol ketal, anisaldehyde methylanthranilate, aurantiol (hydroxycitronellal methylanthranilate), verdantiol (4-tert-butyl-alpha-methyldihydrocinnamaldehyde methyl-anthranilate), vertosine (2,4-dimethyl-3-cyclohexene carbaldehyde), hydroxycitronellal ethylanthranilate, hydroxycitronellal linallylanthranilate, methyl-N-(4-(4-hydroxy-4-methylpentyl)-3-cyclohexenyl-methylidene)anthranilate, methylnaphthylketone methyl-anthranilate, methyl-nonyl-acetaldehyde methylanthranilate, methyl-N-(3,5,5-trimethyl-hexylidene)anthranilate, vanillin methylanthranilate, amyl acetate, amyl propionate, anethol, anisic aldehyde, anisole, benzaldehyde, benzyl acetate, benzyl acetone, benzyl alcohol, benzyl butyrate, benzyl formate, benzyl iso-valerate, benzyl propionate, camphor gum, carvacrol, laevo-carveol, d-carvone, laevo-carvone, citral (neral), citronellol, citronellyl acetate, citronellyl isobutyrate, citronellyl nitrile, citronellyl propionate, para-cresol, para-cresyl methyl ether, cyclohexyl ethyl acetate, cuminic alcohol, cuminic aldehyde, cyclal C (3,5-dimethyl-3-cyclohexene-1-carboxaldehyde), para-cymene, decyl aldehyde, dimethyl benzyl carbinol, dimethyloctanol, diphenyl oxide, dodecalactone, ethyl acetate, ethyl acetoacetate, ethyl amyl ketone, ethyl benzoate, ethyl butyrate, ethyl hexyl ketone, ethyl phenyl acetate, eucalyptol, eugenol, fenchyl alcohol, geraniol, geranyl nitrile, hexenol, beta-gamma-hexenol, hexenyl acetate, cis-3-hexenyl acetate, hexenyl isobutyrate, cis-3-hexenyl tiglate, hexyl acetate, hexyl formate, hexyl neopentanoate, hexyl tiglate, hydratropic alcohol, hydroxycitronellal, indole, alpha-irone, isoamyl alcohol, isobutyl benzoate, isomenthone, isononyl acetate, isononyl alcohol, isobutyl quinoline, isomenthol, para-isopropyl phenylacetaldehyde, isopulegol, isopulegyl acetate, isoquinoline, cis-jasmone, lauric aldehyde (dodecanal), ligustral (2,4-dimethyl-3-cyclohexene-1-carboxaldehyde), linalool, linalool oxide, menthone, methyl acetophenone, para-methyl acetophenone, methyl amyl ketone, methyl anthranilate, methyl benzoate, methyl benzyl acetate, methyl chavicol, methyl eugenol, methyl heptenone, methyl heptine carbonate, methyl heptyl ketone, methyl hexyl ketone, methyl nonyl acetaldehyde, methyl octyl acetaldehyde, methyl salicylate, myrcene, neral, nerol, gamma-nonalactone, nonyl acetate, nonyl aldehyde, allo-ocimene, octalactone, 2-octanol, octyl aldehyde, d-limonene, phenoxy ethanol, phenyl acetaldehyde, phenyl ethyl acetate, phenyl ethyl alcohol, phenyl ethyl dimethyl carbinol, propyl butyrate, rose oxide, 4-terpinenol, alpha-terpineol, terpinolene, tonalid (6-acetyl-1,1,3,4,4,6-hexamethyltetrahydronaphthalene), undecenal, veratrol (1,2-dimethoxybenzene), ambrox (1,5,5,9-tetramethyl-1,3-oxatricyclotridecane), anethole, bacdanol (2-ethyl-4-(2,2,3-trimethyl-3-cyclopenten-1-yl)-2-buten-1-ol), benzyl acetone, benzyl salicylate, butyl anthranilate, calone, cetalox (2-ethyl-4-(2,2,3-trimethyl-3-cyclopenten-1-yl)-2-buten-1-ol), cinnamic alcohol, coumarin, Cyclal C (3,5-dimethyl-3-cyclohexene-1-carboxaldehyde), cymal (2-methyl-3-(4-isopropylphenyl)propionaldehyde), 4-decenal, dihydroisojasmonate, gamma-dodecalactone, ebanol, ethyl anthranilate, ethyl-2-methyl butyrate, ethyl vanillin, eugenol, florhydral (3-(3-isopropylphenyl)butanol), fructone (ethyl-2-methyl-1,3-dioxolane-2-acetate), heliotropin, herbavert (3,3,5-trimethylcyclohexyl ethyl ether), cis-3-hexenyl salicylate, indole, isocyclocitral, isoeugenol, alpha-isomethylionone, keone, lilial (para-tert-butyl alpha-methyl hydrocinnamic aldehyde), linalool, lyral (4-(4-hydroxy-4-methyl-pentyl)-cylcohexene-1-carboxaldehyde), methyl heptine carbonate, methyl anthranilate, methyl dihydrojasmonate, methyl-isobutenyl-tetrahydropyran, methyl beta-naphthyl ketone, methyl nonyl ketone, beta-naphthol methyl ether, nerol, para-anisic aldehyde, para-hydroxyphenyl-butanone, phenylacetaldehyde, gamma-undecalactone and undecylenic aldehyde. Fragrant naturally occurring plant and animal oils and exudates and extracts obtained from plant and animal material may also be used.

The weight ratio of fragrance to carrier particles may be varied in a wide range and is preferably selected to be from 0.01 to 5 and most preferably 0.2 to 3. The weight ratio is selected, depending, on the surface area and on the pore volume of the carrier particles, in such a manner that essentially all of the fragrance is adsorbed to or absorbed into the carrier particles to obtain a perfume delivery system which is a dry, free flowing powder.

C. Process for Making a Perfume Delivery System

The invention also provides a process for making the perfuime delivery system of the present invention. In a first embodiment, the process comprises the steps:
a) reacting water insoluble carrier particles having surface silanol groups with an organosilane having at least one functional group comprising a basic nitrogen atom to obtain carrier particles, wherein at least part of said silanol groups are substituted with organic residues carrying said functional group,
b) reacting the particles obtained in step a) with an alkylating agent to obtain carrier particles, wherein at least part of said organic residues carry at least one functional group comprising an alkylated nitrogen atom carrying a positive charge, and
c) contacting the particles obtained in step b) with a fragrance to adsorb said fragrance onto said particles or absorb said fragrance into said particles.

Functional groups comprising a basic nitrogen atoms are functional groups with a nitrogen atom that can be protonated in the presence of water. Examples of such functional groups are amine, amidine, guanidine, pyridine, imidazole and imidazoline functional groups. Preferably, the functional group is an amino group.

The organosilane reacted with the carrier particles in step a) preferably has the formula (R¹O)₃₋ₙR²ₙSi(CH₂)₃Z, wherein:
R¹ and R² are independently methyl, ethyl, n-propyl or n-butyl,
n is 0 or 1,
Z is NR³R⁴, imidazolyl or 2-imidazolinyl,
R³ and R⁴ are independently hydrogen, methyl, ethyl, C₃₋₂₀ alkyl, C₇₋₂₆ aralkyl,
(CH₂CH₂O)ₘR⁵ or (CH₂CH₂NH)ₘR⁵,
m is from 1 to 4, and
R⁵ is hydrogen, methyl, ethyl, C₃₋₂₀ alkyl or C₇₋₂₆ aralkyl.

The most preferred organosilanes are (MeO)₃Si(CH₂)₃NH₂, (EtO)₃Si(CH₂)₃NH₂, (MeO)₂MeSi(CH₂)₃NH₂, (EtO)₂MeSi(CH₂)₃NH₂, (MeO)₃Si(CH₂)₃NH(CH₂)₃CH₃, (EtO)₃Si(CH₂)₃NH(CH₂)₃CH₃, (MeO)₂MeSi(CH₂)₃NH(CH₂)₃CH₃, (EtO)₂MeSi(CH₂)₃NH(CH₂)₃CH₃, (MeO)₃Si(CH₂)₃NH(CH₂)₂NH₂, (EtO)₃Si(CH₂)₃NH(CH₂)₂NH₂, (MeO)₂MeSi(CH₂)₃NH(CH₂)₂NH₂, (EtO)₂MeSi(CH₂)₃NH(CH₂)₂NH₂, (MeO)₃Si(CH₂)₃NH(CH₂)₂NHCH₂Ph, (EtO)₃Si(CH₂)₃NH(CH₂)₂NHCH₂Ph, (MeO)₂MeSi(CH₂)₃NH(CH₂)₂NHCH₂Ph, (EtO)₂MeSi(CH₂)₃NH(CH₂)₂NHCH₂Ph, (MeO)₃Si(CH₂)₃NH(CH₂)₂NH(CH₂)₂NH₂, (EtO)₃Si(CH₂)₃NH(CH₂)₂NH(CH₂)₂NH₂, (MeO)₂MeSi(CH₂)₃NH(CH₂)₂NH(CH₂)₂NH₂, (EtO)₂MeSi(CH₂)₃NH(CH₂)₂NH(CH₂)₂NH₂, (MeO)₃Si(CH₂)₃Im, (EtO)₃Si(CH₂)₃Im, (MeO)₂MeSi(CH₂)₃Im, (EtO)₂MeSi(CH₂)₃Im, wherein Me is methyl, Et is ethyl, Ph is phenyl and Im is 2-imidazolin-1-yl.

In step a) of the process, the organosilane is preferably reacted with the carrier particles in a weight ratio of from 1:1 to 1:100. More preferably, the weight ratio of organosilane to carrier particles is from 1:5 to 1:50.

The organosilane can be reacted with the carrier particles in a suitable solvent in the absence of water. The reaction is carried out for a suitable time to achieve grafting of the silane onto the carrier particle. The reaction temperature is selected according to the nature of the reactive groups on the silicon atom of the silane and is preferably in the range of 20 to 100° C.

The organosilane can also be reacted with the carrier particles in the presence of water. In this case, the organosilane or a solution of the organosilane is sprayed onto the carrier particles and the resulting mixture is dried to complete the grafting reaction, preferably at a temperature of from 100 to 200 ° C., in particular from 100 to 150 ° C.

The alkylating agent used in step b) may be any compound that is capable of transfering an alkyl group, an aralkyl group or a 2-hydroxyalkyl group onto a basic nitrogen atom. The alkylating agent is preferably selected from the group comprising dimethylsulfate, diethylsulfate, dimethylcarbonate, methyl chloride, methyl bromide and benzyl chloride.

In step b), the reaction can be carried out in any suitable solvent that does not react to a substantial extent with the alkylating agent for a time to achieve at least partial alkylation of the basic nitrogen atom. The reaction temperature is selected according to the nature and reactivity of the alkylating agent and is preferably in the range of 40 to 150 ° C. If the organosilane used in step a) comprises one or more hydrogen atoms bonded to the basic nitrogen atom, one equivalent of a supplemental base for each of these hydrogen atoms is preferably added to the reaction mixture to achieve complete alkylation of the basic nitrogen atom. The supplemental base is preferably a compound that does not react or reacts much slower with the alkylating agent than the basic nitrogen atom.

In step c), the contacting of the particles obtained in step b) with a fragrance is preferably carried out by spraying the fragrance or a solution of the fragrance in one or more suitable solvents onto the carrier particles while maintaining the carrier particles in a free flowing state. The spraying can be performed in a mixer, where the particles are moved by mechanical means, or in a fluidized bed, where the particles are moved by a fluidizing gas. If a solvent is used, the solvent may be conveniently removed during the spraying step, although this is not necessary.

In the second embodiment of the process for making the perfume delivery system, the process comprises the steps:
a) reacting an organosilane having at least one functional group comprising a basic nitrogen atom with an alkylating agent to obtain an organosilane having at least one functional group comprising an alkylated nitrogen atom carrying a positive charge,
b) reacting the product obtained in step a) with insoluble carrier particles having surface silanol groups to obtain carrier particles, wherein at least part of said silanol groups are substituted with organic residues carrying said functional group comprising an alkylated nitrogen atom carrying a positive charge, and
c) contacting the particles obtained in step b) with a fragrance to adsorb said fragrance onto said particles or absorb said fragrance into said particles.

In a second embodiment of a process for making the perfume delivery system of the invention, the steps of grafting an organosilane to the carrier particles and of alkylating a basic nitrogen atom comprised in a functional group carried by the organosilane are essentially reversed. Therefore, in step a) of the second embodiment the same organosilanes as in step a) of the first embodiment and the same alkylating agents as in step b) of the first embodiment are used. Reaction conditions in step a) are preferably the same as for step b) of the first embodiment and reaction conditions for step b) are preferably the same as for step a) of the first embodiment. Step c) is carried out in the same way as in the first embodiment.

In a third embodiment of the process for making the perfume delivery system, the process comprises the steps:
a) reacting water insoluble carrier particles having surface silanol groups with an organosilane having at least one functional group comprising a basic nitrogen atom or a hydroxy radical to obtain carrier particles, wherein at least part of said silanol groups are substituted with organic residues carrying said functional group,
b) reacting the particles obtained in step a) with a quaternary ammonium compound comprising an epoxy or chlorohydrin functional group to obtain carrier particles, wherein at least part of said organic residues carry at least one functional group comprising a quaternary ammonium group, and
c) contacting the particles obtained in step b) with a fragrance to adsorb said fragrance onto said particles or absorb said fragrance into said particles.

In the third embodiment of a process for making the perfume delivery system of the invention, step a) is carried out in the same way as step a) of the first embodiment and the same reaction conditions are used. The same organosilanes having at least one functional group comprising a basic nitrogen atom can be used. Among these organosilanes, the same compounds are preferred as with the first embodiment. However, in the third embodiment, organosilanes having at least one functional group comprising a hydroxy radical can be used as well.

In step b) the particles obtained in step a) are reacted with a quaternary ammonium compound comprising an epoxy or chlorohydrin functional group. This compound reacts at the epoxy or chlorohydrin functional group with at least part of the basic nitrogen atoms or hydroxy radicals in a nucleophilic substitution reaction to attach a quaternary ammonium group to the organic residues that were grafted onto the carrier particles in step a). In step b) of the third embodiment, the same reaction conditions as in step b) of the first embodiment can be used. Also, the same supplemental base is preferably added if the quaternary ammonium compound comprises a chlorohydrin functional group. The quaternary ammonium compound comprising an epoxy functional group is preferably trimethyl-1-(2,3-epoxypropyl)ammonium chloride. The quaternary ammonium compound comprising a chlorohydrin functional group is preferably trimethyl-1-(3-chloro-2-hydroxypropyl) ammonium chloride.

Step c) of the third embodiment is carried out in the same way as step c) of the first embodiment.

D. Fabric Softening Composition

The invention further provides fabric softening compositions comprising the perfume delivery system of the present invention and one or more fabric softening active quaternary ammonium compounds. A fabric softening active quaternary ammonium compound is a quaternary ammonium compound which when contacted with a fabric will impart a soft touch to the fabric.

Suitable fabric softening active quaternary ammonium compounds are compounds of formula (I);
R⁶₄₋ₘN⁺[(CH₂)ₙ-Q-R⁷]ₘX⁻ (I),
wherein:
each R⁶ is independently C₁-C₆ alkyl, C₁-C₆ hydroxyalkyl or benzyl and preferably is methyl;
R⁷ is independently hydrogen, C₁₁-C₂₂ linear alkyl, C₁₁-C₂₂ branched alkyl, C₁₁-C₂₂ linear alkenyl or C₁₁-C₂₂ branched alkenyl, with the proviso that at least one of R⁷ is not hydrogen;
Q is independently selected from the units having the formula —O—C(O)—, —C(O)O—, —NR⁸—C(O)—, —C(O)—NR⁸—, —O—C(O)—O—, —CHR⁹—O—C(O)— or —CH(OCOR⁷)—CH₂—O—C(O)—, wherein
R⁸ is hydrogen, methyl, ethyl, propyl or butyl and R⁹ is hydrogen or methyl and preferably Q is —O—C(O)— or —NH—C(O)—;
m is from 1 to 4 and preferably 2 or 3;
n is from 1 to 4 and preferably 2; and
X⁻ is a softener compatible anion, for example, chloride, bromide, methylsulfate, ethylsulfate, sulfate or nitrate, preferably chloride or methyl sulfate.

The fabric softening active quaternary ammonium compounds of formula (I) can be mixtures of compounds with the number of groups R⁷ per molecule which are not hydrogen ranging from 1 to m. Preferably, such mixtures comprise on average from 1.2 to 2.5 groups R⁷ per molecule which are not hydrogen. More preferably, the amount of non-hydrogen R⁷ groups is from 1.4 to 2.0 and most preferably from 1.6 to 1.9.

The most preferred compounds of formula (I) are the compounds of formulae (II) to (IV):
R⁶N⁺[CH₂CHR⁹OH][CH₂CHR⁹OC(O)R⁷]₂X⁻ (II)
R⁶₂N⁺[CH₂CHR⁹OC(O)R⁷]₂X⁻ (III)
R⁶N⁺[CH₂CHR⁹OH][CH₂CH₂NHC(O)R⁷]₂X⁻ (IV)
wherein R⁶, R⁷ and X have the same meaning as defined for formula (I) above, with the proviso that R⁷ is not hydrogen.

Preferably, the unit —C(O)R⁷ is a fatty acyl moiety. Suitable fatty acyl moieties are derived from natural sources of triglycerides, preferably tallow, vegetable oils, partially hydrogenated tallow and partially hydrogenated vegetable oils. Suitable sources of triglycerides are soy, tallow, partially hydrogenated tallow, palm, palm kernel, rape seed, lard, coconut, canola, safflower, corn, rice and tall oil. The formulator, depending upon the desired physical and performance properties of the final fabric softener, can choose any of the above mentioned sources of fatty acyl moieties, or alternatively, the formulator can mix sources of triglyceride to form a blend.

Those skilled in the art of fats and oils recognize that the fatty acyl composition may vary, as in the case of vegetable oil, from crop to crop, or from variety of vegetable oil source to variety of vegetable oil source. The R⁷ groups are typically mixtures of linear and branched chains of both saturated and unsaturated aliphatic fatty acids.

The fraction of unsaturated groups R⁷ in such mixture is preferably at least 10%, most preferably at least 25% and most preferably from 40% to 70%. The fraction of polyunsaturated groups R⁷ in such mixture is preferably less than 10%, more preferably less than 5% and most preferably less than 3%. Partial hydrogenation can be employed, if required, to minimize the polyunsaturate levels in order to improve the stability (e.g., odor, color, etc.) of the final product. The level of unsaturation, expressed by the iodine value, should preferably be in the range of from 5 to 150 and more preferably in the range from 5 to 50. The ratio of cis and trans isomers of double bonds in the unsaturated groups R⁷ is preferably larger than 1:1 and most preferably in the range 4:1 to 50:1.

Preferred examples of compounds of formula (I) are:
N,N-di(tallowyl-oxy-ethyl)-N,N-dimethyl ammonium chloride;
N,N-di(canolyl-oxy-ethyl)-N,N-dimethyl ammonium chloride;
N,N-di(tallowyl-oxy-ethyl)-N-methyl, N-(2-hydroxyethyl) ammonium methyl sulfate;
N,N-di(canolyl-oxy-ethyl)-N-methyl, N-(2-hydroxyethyl) ammonium methyl sulfate;
N,N-di(tallowylamidoethyl)-N-methyl, N-(2-hydroxyethyl) ammonium methyl sulfate;
N,N-di(2-tallowyloxy-2-oxo-ethyl)-N,N-dimethyl ammonium chloride;
N,N-di(2-canolyloxy-2-oxo-ethyl)-N,N-dimethyl ammonium chloride;
N,N-di(2-tallowyloxyethylcarbonyloxyethyl)-N,N-dimethyl ammonium chloride;
N,N-di(2-canolyloxyethylcarbonyloxyethyl)-N,N-dimethyl ammonium chloride;
N-(2-tallowoyloxy-2-ethyl)-N-(2-tallowyloxy-2-oxo-ethyl)-N,N-dimethyl ammonium chloride;
N-(2-canolyloxy-2-ethyl)-N-(2-canolyloxy-2-oxo-ethyl)-N,N-dimethyl ammonium chloride;
N,N,N-tri(tallowyl-oxy-ethyl)-N-methyl ammonium chloride;
N,N,N-tri(canolyl-oxy-ethyl)-N-methyl ammonium chloride;
1,2-ditallowyloxy-3-N,N,N-trimethylammoniopropane chloride; and
1,2-dicanolyloxy-3-N,N,N-trimethylanumoniopropane chloride.

Also suitable as fabric softening active quaternary ammonium compounds are compounds of formula (V):
R⁶₂R⁷₂N⁺X⁻ (v),
wherein:
R⁶, R⁷ and X have the same meaning as defined for formula (I) above, with the proviso that R⁷ is not hydrogen.

Preferred examples of compounds of formula (V) are ditallowdimethylammonium chloride, ditallowdimethylammonium methylsulfate, di(hydrogenatedtallow)dimethyl-ammonium chloride, distearyldimethylammonium chloride and dibehenyldimethylammonium chloride.

Further suitable as fabric softening active quaternary ammonium compounds are compounds of formulae (VI) and (VII): 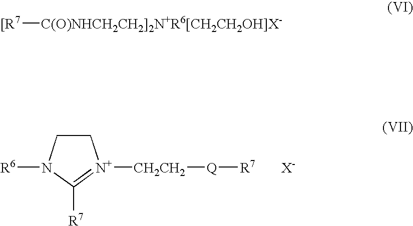
wherein R⁶, R⁷ and X have the same meaning as defined for formula (I) above, with the proviso that R⁷ is not hydrogen, and Q is —O—C(O)— or —NH—C(O)—.

For application as rinse cycle softeners, the fabric softening compositions of the invention preferably comprise from 0.1 to 5 wt % of the perfume delivery system, from 1 to 50 wt. % of fabric softening active quaternary ammonium compounds and water. More preferably, the fabric softening compositions comprise from 0.2 to 2 wt. % of the perfume delivery system and most preferably from 0.3 to 1.0 wt. %.

In addition to the perfume delivery system, one or more fabric softening active quaternary ammonium compounds and water, such fabric softening compositions may comprise further additives known from the prior art for formulating aqueous fabric softening compositions, such as viscosity and dispersibility aids, stabilizers, soil release agents, bactericides, nonionic softeners, colorants, preservatives, optical brighteners, opacifiers, fabric conditioning agents, surfactants, anti-shrinkage agents, anti-wrinkle agents, fabric crisping agents, anti-spotting agents, fungicides, anti-corrosion agents and/or antifoam agents. Suitable additives are disclosed in U.S. Pat. No. 6,737,392 in column 8, line 1 to column 14, line 6, and are hereby incorporated by reference.

For application as dryer-added softeners, the fabric softening compositions of the invention preferably comprise a mixture containing from 0.1 to 5 wt. % of the perfume delivery system and from 1 to 99 wt. % of fabric softening active quaternary ammonium compounds disposed on an absorbent article. More preferably, the fabric softening compositions comprise from 0.2 to 2 wt.-% of the perfume delivery system and most preferably from 0.3 to 1.0 wt. %.

Absorbent articles with a fabric softening active material disposed thereon, which are useful as dryer-added softeners and methods for disposing a fabric softening composition on a suitable absorbent article are well known from the prior art. Preferably, the absorbent article has the shape of a sheet comprising a woven or non-woven fiber material. More preferably, the sheet is a paper sheet or a non-woven fleece or a woven cloth made from cellulose, regenerated cellulose or polyester fibers. Suitable sheets of woven and non-woven fiber material and methods for deposing a fabric softening composition on said sheets are disclosed in U.S. Pat. No. 3,686,025, which is incorporated herein by reference. In such an embodiment, the fabric softening composition may be disposed either on the surface of the sheet or preferably in between the fibers of the sheet. In an alternative embodiment, the absorbent article comprises a sponge like or open pore rigid foam material with the fabric softening composition disposed in the pores of the sponge or foam.

In addition to fabric softening active quaternary ammonium compounds, the fabric softening compositions for use as dryer-added softeners may further comprise one or more co-softeners, which are carboxylic acid salts of tertiary amines having the structure:
R¹⁰R¹¹R¹²NH⁺R¹³COO⁻
wherein R¹⁰ is a long chain alkyl or alkenyl group containing from about 8 to about 30 carbon atoms; R¹¹ and R¹² are the same or different and are selected from the group consisting of alkyl groups containing from 1 to 30 carbon atoms, hydroxyalkyl groups containing from 2 to 30 carbon atoms, and alkyl ether groups of the formula R¹⁴(OCHR¹⁵CH₂)ₙ, wherein R¹⁴ is hydrogen, an alkyl group containing from 1 to 30 carbon atoms or an alkenyl group containing from 3 to 30 carbon atoms, R¹⁵ is hydrogen or methyl and n is from 1 to 30; wherein R¹⁰, R¹¹, R¹² and R¹⁴ chains can be ester interrupted groups; and wherein R¹³ is an alkyl, alkenyl, aryl, alkaryl or aralkyl group comprising 8 to 30 carbon atoms. The amine and the acid, used to form the amine salt may both be of mixed chain lengths rather than single chain lengths and may comprise materials derived from natural fats and oils or synthetic processes which produce a mixture of chain lengths. The co-softeners preferably have a softening point in the range from 35° C. to 100° C.

Preferred tertiary amines used as starting materials to form the co-softener tertiary amine salts are lauryldimethylamine, myristyldimethylamine, stearyldimethylamine, tallowdimethylamine, coconutdimethylamine, dilaurylmethylamine, distearylmethylamine, ditallowmethylamine, oleyldimethylamine, dioleylmethylamine, lauryl-di(3-hydroxypropyl) amine, stearyl-di(2-hydroxyethyl)amine, trilaurylamine and laurylethylmethylamine. Preferred carboxylic acids used as starting materials to form the co-softener tertiary amine salts are stearic acid, oleic acid, lauric acid, myristic acid and palmitic acid.

In addition to the perfume delivery system, one or more fabric softening active quaternary ammonium compounds and an absorbent substrate, such fabric softening compositions for use as dryer-added softeners may comprise further additives known from the prior art for formulating fabric softeners, such as nonionic surfactants, fatty acids and alkoxylated fatty acids, stabilizers, soil release agents, bactericides, nonionic softeners, colorants, preservatives, optical brighteners, fabric conditioning agents, surfactants, anti-shrinkage agents, anti-wrinkle agents, fabric crisping agents, anti-spotting agents, fungicides and/or anti-corrosion agents. Suitable additives are disclosed in U.S. Pat. No. 6,737,392 in column 9, line 47 to column 14, line 6, and are hereby incorporated by reference.

The fabric softening compositions of the invention impart a stronger and longer lasting fragrance to fabrics treated with said compositions compared to fabrics treated with compositions comprising perfume delivery systems of the prior art. Such fabric softening compositions may therefore be formulated with a lower amount of fragrant compounds as used in the prior art.

E. Laundry Detergent Compositions

The invention further provides laundry detergent compositions comprising the perfume delivery system of the present invention and one or more surfactants. The term laundry detergent composition as used in this invention encompasses all compositions that can be used to clean fabrics in an aqueous wash liquid.

The laundry detergent compositions of the invention may be solid compositions. Such solid compositions may have the appearance of powders, granulates or molded bodies. Compositions in the form of granulates or molded bodies may comprise the perfume delivery system in the form of particles separate from the granulates or molded bodies. Alternatively, the perfume delivery system may be incorporated into granulates or molded bodies comprising further constituents of the laundry detergent composition. The molded bodies may have the shape of extrudates, pellets, briquettes or tablets. Such molded bodies may be prepared by processes of press agglomeration, such as for example extrusion, briquetting or tabletting. Laundry detergent composition in the form of press molded bodies may contain additional binders to improve the hardness of the molded bodies. However, laundry detergent composition in the form of press molded bodies are preferably made without the use of additional binders with one of the wash active components, preferably a nonionic surfactant, acting as the binder.

In a further embodiment, the laundry detergent compositions of the invention may be liquid or gel compositions with the perfume delivery system of the present invention dispersed in the liquid or gel phase. Apart from the perfume delivery system, further solid components of the detergent may be dispersed in the liquid or gel phase. The rheologic properties of the liquid or gel composition are preferably selected to maintain all solid components dispersed in the liquid or gel phase during storage with no settling of solids. Preferably, the liquid or gel composition shows thixotropic or pseudoplastic flow. Such flow properties may be achieved by additives, such as dispersable clays, in particular montmorillonites; precipitated or pyrogenic silicas; vegetable gums, in particular xanthanes; and synthetic polymeric thickeners, such as vinyl polymers comprising carboxyl groups.

The laundry detergent compositions of the present invention comprise one or more surfactants, preferably anionic, nonionic or cationic surfactants or combinations thereof. Suitable anionic surfactants are for example surfactants with sulfonate groups, preferably alkylbenzenesulfonates, alkanesulfonates, alpha-olefinsulfonates, alpha-sulfofatty acid esters or sulfosuccinates. Preferred alkylbenzenesulfonates comprise a linear or branched chain alkyl group with 8 to 20 carbon atoms, in particular 10 to 16 carbon atoms. Preferred alkanesulfonates comprise a linear chain alkyl group with 12 to 18 carbon atoms. Preferred alpha-olefinsulfonates are the products of sulfonating alpha-olefins having 12 to 18 carbon atoms. Preferred alpha-sulfofatty acid esters are the products of sulfonating fatty acid esters of fatty acids having 12 to 18 carbon atoms and short chain alcohols selected from methanol, ethanol, 1-propanol and 2-propanol.

A further class of suitable anionic surfactants are surfactants comprising sulfate groups, preferably alkylsulfates and ethersulfates. Preferred alkylsulfates comprise a linear chain alkyl group with 12 to 18 carbon atoms. Also suitable are beta-branched alkylsulfates and alkylsulfates comprising one or more branchings at the center of the alkyl group. Preferred ethersulfates are the products of ethoxylating linear chain alcohols having 12 to 18 carbon atoms with 2 to 6 ethylene oxide units and subsequent sulfatation.

Another class of suitable anionic surfactants are soaps, such as for example alkali metal salts of lauric acid, myristic acid, palmitic acid, stearic acid or mixtures thereof and alkali metal salts of natural fatty acid mixtures, such as for example coconut fatty acid, palm kernel fatty acid or tallow fatty acid.

Suitable non-ionic surfactants are for example alkoxylated compounds, in particular ethoxylated and propoxylated compounds. Preferred are condensation products of alkylphenols or fatty alcohols with 1 to 50 equivalents ethylene oxide, propylene oxide or mixtures thereof and in particular condensation products with 1 to 10 equivalents. Another class of suitable non-ionic surfactants are polyhydroxyfatty acid amides with the amide nitrogen substituted by an organic residue carrying one or more hydroxyl groups which may additionally be alkoxylated. A further class of suitable non-ionic surfactants are alkyl glycosides comprising a linear or branched chain alkyl group with 8 to 22 carbon atoms, in particular 12 to 18 carbon atoms, and a mono- or diglycoside unit which is preferably derived from glucose.

Suitable cationic surfactants are for example monoalkoxylated or dialkoxylated quaternary ammonium compounds comprising one or two hydroxyalkyl groups and an alkyl group with 6 to 18 carbon atoms bonded to nitrogen.

The laundry detergent compositions of the present invention may comprise further components, such as for example builders, alkaline components, bleaching agents, bleach activators, enzymes, chelating agents, graying inhibitors, foam inhibitors, brighteners or colorants. Suitable as builders are all compounds or compositions that are capable of sequestering calcium or magnesium ions from an aqueous solution. Preferred builders are alkali metal phosphates and alkali metal polyphosphates, in particular pentasodium triphosphate; water soluble or water insoluble sodium silicates, in particular layered silicates of the formula Na₅Si₂O₅; zeolites of the structure type A, X and P and mixtures thereof; and trisodium citrate. Organic co-builders may be used in addition to builders, such as for example polyacrylic acid, polyaspartic acid and copolymers of acrylic acid with methacrylic acid, acrolein or sulfonated vinyl monomers and alkali metal salts thereof as well as mixtures thereof.

Suitable alkaline components for laundry detergent compositions of the present invention provide a pH value in the range of 8 to 12 in the aqueous wash liquid at the use concentration of the laundry detergent. Preferred alkaline components are sodium carbonate, sodium sesquicarbonate and sodium metasilicate. Suitable are also other soluble alkali metal silicates.

Suitable bleaching agents for laundry detergent compositions of the present invention are peroxygen compounds, such as alkali metal perborates, alkali metal carbonate perhydrates, alkali metal persilicates, alkali metal persulfates, alkali metal peroxophosphates, alkali metal peroxopyrophosphates, diacyl peroxides, aromatic peroxy acids and aliphatic peroxy acids. Preferred bleaching agents are sodium perborate tetrahydrate, sodium perborate monohydrate, sodium carbonate perhydrate, peroxylauric acid, peroxystearic acid, epsilon-phthalimidoperoxycarboxylic acids, 1,12-diperoxydodecanedioic acid, 1,9-diperoxyazelaic acid and 2-decyldiperoxybutane-1,4-dioic acid. Most preferred are sodium perborate tetrahydrate, sodium perborate monohydrate and coated sodium carbonate perhydrate. Coated sodium carbonate perhydrate suitable for use in liquid detergent compositions is known from WO 2004/056955, which is hereby incorporated by reference.

Suitable bleaching activators for laundry detergent compositions of the present invention are compounds with acyl groups bonded to nitrogen or oxygen atoms, which can undergo a perhydrolysis reaction with hydrogen peroxide in aqueous solution to give a peroxycarboxylic acid. Preferred compounds of this type are peracylated alkylenediamines, in particular tetraacetylethylenediamine (TAED); acylated triazinones, in particular 1,5-diacetyl-2,4-dioxohexahydro-1,3,5-triazine (DADHT); acylated glycolurils, in particular tetraacetylglycoluril (TAGU); N-acylimides, in particular N-nonanoylsuccinimide (NOSI); acylated phenolsulfonates, in particular n-nonanoyloxybenzenesulfonate and iso-nonanoyloxybenzenesulfonate salts (n-NOBS and iso-NOBS); carboxylic acid anhydrides such as phthalic acid anhydride; acylated polyhydric alcohols, such as ethyleneglycol diacetate, 2,5-diacetoxy-2,5-dihydrofuran, acetylated sorbitol and mannitol and acylated sugars, such as pentaacetylglucose; N-acylated lactams, in particular N-acetylcaprolactam, N-acetylvalerolactam, N-nonanoylcaprolactam and N-nonanoylvalerolactam.

A further class of suitable bleaching activators are the nitriles comprising amine or quaternary ammonium groups known from Tenside Surf. Det. 1997, 34(6), pages 404-409, which are hereby incorporated by reference.

Another class of suitable bleaching activators are transition metal complexes capable of activating hydrogen peroxide for stain bleaching. Suitable transition metal complexes are known from EP-A 0 544 490 page 2, line 4 to page 3, line 57; WO 00/52124 page 5, line 9 to page 8, line 7 and page 8, line 19 to page 11, line 14; WO 04/039932, page 2, line 25 to page 10, line 21; WO 00/12808 page 6, line 29 to page 33, line 29; WO 00/60043 page 6, line 9 to page 17, line 22; WO 00/27975, page 2, line 1 to 18 and page 3, line 7 to page 4, line 6; WO 01/05925, page 1, line 28 to page 3, line 14; WO 99/64156, page 2, line 25 to page 9, line 18; and GB-A 2 309 976, page 3, line 1 to page 8, line 32, which are hereby incorporated by reference.

The laundry detergent compositions of the present invention may further comprise enzymes that enhance the cleaning action, preferably lipases, cutinases, amylases, neutral and alkaline proteases, esterases, cellulases, pectinases, lactases and peroxidases and mixtures thereof. The enzymes may be coated or may be adsorbed to one or more carrier components to protect them against loss of enzyme activity.

The laundry detergent compositions of the present invention may also comprise chelating agents which are capable of sequestering transition metal ions and can inhibit the decomposition of peroxygen compounds in the detergent compositions and in the wash liquid during use of the detergent composition. Preferred chelating agents are phosphonic acids, in particular hydroxyethane-1,1-disphosphonate, nitrilotrimethylenephosphonate, diethylenetriamine-penta(methylenephosphonate), ethlyenediamine-tetra(methylenephosphonate) and hexamethylenediamine-tetra(methylenephosphonate); nitrilotriacetic acid; polyaminocarboxylic acids, in particular ethylenediaminetetraacetic acid, diethylenetriaminepentaacetic acid, ethylenediamine-N,N′-disuccinic acid, methylglycin-diacetic acid and polyaspartic acid; polyvalent carboxylic acids and hydroxycarboxylic acids, in particular tartaric acid and citric acid; and the alkali metal and ammonium salts of said preferred chelating agents.

The laundry detergent compositions of the present invention may further comprise graying inhibitors which keep soil particles suspended in the wash liquid and inhibit the redeposition of soil onto fibers. Suitable graying inhibitors are for example cellulose ethers, preferably carboxymethylcellulose and alkali metal salts thereof, methylcellulose, hydroxyethylcellulose, hydroxypropylcellulose and polyvinylpyrrolidone.

The laundry detergent compositions of the present invention may also comprise foam inhibitors which reduce foam formation from the wash liquid during use. Suitable foam inhibitors are for example organopolysiloxanes, preferably polydimethylsiloxane, paraffins, waxes, as well as mixtures thereof with small particle silicas. Such foam inhibitors are well known in the art.

The laundry detergent compositions of the present invention may also comprise brighteners which can compensate the yellowing of fibers by adsorbing to the fiber, absorbing UV light and reemitting blue light by fluorescence. Suitable brighteners are for example derivatives of diaminostilbenedisulfonic acid, such as 4,4′-bis-(2-anilino-4-morpholino-1,3,5-triazinyl-6-amino)-stilbene-2,2′-disulfonic acid and alkali metal salts thereof or substituted diphenylstyryls, such as 4,4′-bis-(2-sulfostyrlyl)-diphenyl and alkali metal salts thereof.

The laundry detergent compositions of the present invention may further comprise colorants to provide the compositions with a more pleasing appearance.

Laundry detergent compositions of the present invention in the form of liquids or gels may further comprise up to 30 wt.-% of an organic solvent, preferably methanol, ethanol, n-propanol, iso-propanol, n-butanol, ethylene glycol, 1,2-propylene glycol, 1,3-propylene glycol, 1,4-butylene glycol, glycerin, diethylene glycol, ethylene glycol methyl ether, ethanolamine, diethanolamine or triethanolamine or mixtures thereof.

The laundry detergent compositions of the invention impart a stronger and longer lasting fragrance to fabrics treated with said compositions compared to fabrics treated with compositions comprising perfume delivery systems of the prior art. Such laundry detergent compositions may therefore be formulated with a lower amount of fragrant compounds as used in the prior art.

F. Further Uses

The perfume delivery system of the invention may also be used to deliver perfume to other surfaces than fabrics, such as skin, hair or solid surfaces. They may therefore also be used advantageously in personal care products, such as hair shampoos, hair conditioners, body washes, shower gels, soaps, skin care creams and lotions, skin conditioners, sunscreens, deodorants, antiperspirants or color cosmetics. They may further be used in toilet bowl cleaners, toilet bowl gels, car shampoos and rinse aids.

### EXAMPLES

The following examples are provided to illustrate the present invention without intending to limit the scope of the invention.

### Example 1

### Preparation of Cationic Organosilane

157.4 g 3-aminopropyltriethoxysilane (Dynasilane AMEO) and 124 g deionized water were placed in a 600 ml Parr reactor. The reactor was evacuated and flushed with nitrogen three times to remove air. The reactor was heated to 70° C., closed and 36 g of methyl chloride were added over 30 min. After the initial exotherm, the reaction mixture was heated to 90° C. for the rest of the reaction. When the pressure inside the reactor had dropped to less than 0.34 bar (5 psi), 127.8 g of 22.3 wt % aqueous sodium hydroxide was added and the mixture was stirred for 30 min. Then, further 36 g of methyl chloride was added and the mixture was stirred until the pressure inside the reactor had dropped to less than 0.34 bar (5 psi). A second portion of 127.8 g of 22.3 wt % aqueous sodium hydroxide was added and the mixture was stirred for 30 min. Thereafter, a third portion of methyl chloride was added and the mixture was stirred until the pressure inside the reactor had dropped to less than 0.34 bar (5 psi). Finally, the reaction mixture was cooled to ambient temperature and the precipitate formed in the reaction was filtered off to give an aqueous solution of cationic organosilane.

### Example 2

### Grafting of Silica with a Cationic Organosilane

4.44 g of the solution of cationic organosilane prepared in example 1 was diluted with 10 ml deionized water and added in 1 ml portions to 20 g precipitated silica Sipernat 22 made by Degussa AG at room temperature while constantly mixing the silica. The resulting product was heated for 15 h at 110° C. in a forced air oven to remove water and complete the grafting reaction.

### Example 3

### Grafting of Silica with a Cationic Organosilane

Example 2 was repeated, but granulated fumed silica Aeroperl 300/30 made by Degussa AG was used in place of precipitated silica Sipernat 22.

### Example 4

### Preparation of Perfume Delivery System

1 g of the dry product obtained in example 2 was placed in a mixer and 2 g of liquid fragrance composition 5862-HBH-LFS made by International Flavors & Fragrances Inc. was added slowly while mixing the grafted silica. A perfume carrier system comprising 67 wt % fragrance on carrier was obtained as a free flowing powder.

### Example 5

### Preparation of Perfume Delivery System

Example 4 was repeated, but the dry product obtained in Example 3 was used in place of the dry product obtained in Example 2.

### Example 6

### Grafting of Silica with an Aminosilane (Comparative Example)

2 g of 3-aminopropyltriethoxysilane (Dynasilane AMEO) were dissolved in 10 ml deionized water and 3.25 g of 10 wt.-% aqueous hydrochloric acid were added at room temperature. The resulting solution was added in 1 ml portions to 20 g precipitated silica Sipernat 22 made by Degussa AG at room temperature while constantly mixing the silica. The resulting product was heated for 15 h at 110° C. in a forced air oven to remove water and complete the grafting reaction.

### Example 7

### Grafting of Silica with an Aminosilane (Comparative Example)

Example 6 was repeated, but granulated fumed silica Aeroperl 300/30 made by Degussa AG was used in place of precipitated silica Sipernat 22.

### Example 8

### Preparation of Perfume Delivery System (Comparative Example)

Example 4 was repeated, but the dry product obtained in Example 6 was used in place of the dry product obtained in Example 2.

### Example 9

### Preparation of Perfume Delivery System (Comparative Example)

Example 4 was repeated, but the dry product obtained in Example 7 was used in place of the dry product obtained in Example 2.

### Example 10

### Fabric Softening Composition

Varisoft WE 16, which is a 90 wt % solution in isopropanol of the reaction product of hydrogenated tallow fatty acid with triethanolamine, quaternized with dimethyl sulfate, was used as fabric softening active composition. Varisoft WE 16 comprises N,N-di(tallowyloxyethyl)-N-methyl-N-(2-hydroxyethyl)-ammonium methylsulfate as the major component. 33 g Varisoft WE 16 were heated to 40° C. and slowly added to 165.4 g deionized water with stirring. 0.66 g of a 25 wt % solution of calcium chloride were added in parallel to control the viscosity of the mixture. The dispersion obtained was cooled to room temperature and 2.09 g of the perfume delivery system prepared in Example 4 was added with stirring. The mixture was stirred slowly for a further 2 h to evenly distribute the perfume delivery system in the dispersion. The resulting dispersion contained about 15 wt % fabric softening actives and about 0.7 wt % fragrance comprised in the perfume delivery system. The dispersion had a pH of 4.5 and a viscosity in the range of 40 to 170 cps measured with a Brookfield viscosimeter at room temperature using spindle no. 2.

### Example 11

### Fabric Softening Composition

Example 10 was repeated, but the perfume delivery system prepared in Example 5 was used in place of the perfume delivery system prepared in Example 4.

### Example 12

### Fabric Softening Composition (Comparative Example)

Example 10 was repeated, but the perfume delivery system prepared in Example 8 was used in place of the perfume delivery system prepared in Example 4.

### Example 13

### Fabric Softening Composition (Comparative Example)

Example 10 was repeated, but the perfume delivery system prepared in Example 9 was used in place of the perfume delivery system prepared in Example 4.

### Example 14

### Fabric Softening Composition (Comparative Example)

Example 10 was repeated, but 1.44 g of liquid fragrance composition 5862-HBH-LFS made by International Flavors & Fragrances Inc. was used in place of the perfume delivery system prepared in Example 4.

### Application Testing of Fabric Softening Compositions

Four cotton towels and three sheets of a 50% cotton -50% polyester fabric with a total weight of about 1700 g were washed in a standard Kenmore laundry washer with a cold wash and cold rinse setting using 50 g of 1993 AATCC (American Association of Textile Chemists and Colorists) standard reference detergent. At the beginning of the rinse cycle, 22.7 g of fabric softening composition was added to the washer. The washed fabric bundle was dried for 1 h in a standard Kenmore laundry drier. The dried cotton towels were stored at room temperature and assessed for fragrance intensity after 12 h and 7 days storage. Fragrance intensity was evaluated with the pair wise ranking method described in Sensory Evaluation Techniques, M. Meilgaard, G. V. Civille, B. T. Carr, CRC Press, pages 88 to 91, 254 and 268, using a panel of 4 or 5 panelists.

Two sets of fabric softening compositions were evaluated:

Set 1:
Example 12 (comparative example)
Example 10
Example 14 (comparative example)

Set 2:
Example 13 (comparative example)
Example 11
Example 14 (comparative example)

Results of pair-wise rankings are shown in Tables 1 to 4 with the numbers indicating the number of rankings where the composition specified in the column label had a stronger fragrance than the composition specified in the row label.

In all rankings, the fabric softening compositions of Examples 10 and 11 comprising a perfume delivery system according to the invention provided a significantly higher level of fragrance than the fabric softening compositions of Example 14 comprising no carrier system or those of Examples 12 and 13 comprising a carrier system of silica grafted with an aminosilane. The perfume delivery system of the invention imparted the fabrics with a more intensive and longer lasting fragrance.

TABLE 1
Set 1, Fragrance intensity after 12 h

| | Example 12* | Example 10 | Example 14* |
|---|---|---|---|
| Example 12* | | 8 | 4 |
| Example 10 | 2 | | 1 |
| Example 14* | 6 | 9 | |

*Comparative examples

TABLE 2
Set 1, Fragrance intensity after 7 days

| | Example 12* | Example 10 | Example 14* |
|---|---|---|---|
| Example 12* | | 10 | 3 |
| Example 10 | 0 | | 2 |
| Example 14* | 7 | 8 | |

*Comparative examples

TABLE 3
Set 2, Fragrance intensity after 12 h

| | Example 13* | Example 11 | Example 14* |
|---|---|---|---|
| Example 13* | | 9 | 7 |
| Example 11 | 1 | | 1 |
| Example 14* | 3 | 9 | |

*Comparative examples

TABLE 4
Set 2, Fragrance intensity after 7 days

| | Example 13* | Example 11 | Example 14* |
|---|---|---|---|
| Example 13* | | 8 | 4 |
| Example 11 | 0 | | 0 |
| Example 14* | 4 | 8 | |

*Comparative examples

All references cited herein are fully incorporated by reference. Having now fully described the invention, it will be understood by those of skill in the art that the invention may be practiced within a wide and equivalent range of conditions, parameters and the like, without affecting the spirit or scope of the invention or any embodiment thereof.

What is claimed is:

1. A perfume delivery system comprising:
a) water insoluble carrier particles having surface silanol groups, wherein at least part of said silanol groups are substituted with organic residues by grafting with at least one organosilane and wherein at least part of said organic residues carry positively charged functional groups, and
b) a fragrance adsorbed to or absorbed into said carrier particles.

2. The perfume delivery system of claim 1, wherein the carrier particles comprise silica, a silicate, an aluminosilicate or a mixture thereof.

3. The perfume delivery system of claim 2, wherein the silica is selected from the group consisting essentially of: precipitated silicas, fumed silicas and silica gels.

4. The perfume delivery system of claim 2, wherein the aluminosilicate is a zeolite.

5. The perfume delivery system of claim 4, wherein the zeolite is selected from the group consisting essentially of: zeolite X; zeolite Y; and dealuminated zeolite Y.

6. The perfume delivery system of claim 1, wherein essentially all of the organic residues carry at least one positively charged functional group.

7. The perfume delivery system of claim 1, wherein the positively charged functional groups are quaternary ammonium groups.

8. The perfume delivery system of claim 1, wherein the weight ratio of fragrance to carrier particles is from 0.01 to 5.

9. A process for preparing a perfume delivery system according to claim 1, comprising the steps:
a) reacting water insoluble carrier particles having surface silanol groups with an organosilane having at least one functional group comprising a basic nitrogen atom to obtain carrier particles, wherein at least part of said silanol groups are substituted with organic residues carrying said functional group;
b) reacting the particles obtained in step a) with an alkylating agent to obtain carrier particles, wherein at least part of said organic residues carry at least one functional group comprising an alkylated nitrogen atom carrying a positive charge; and
c) contacting the particles obtained in step b) with a fragrance to adsorb said fragrance onto said particles or absorb said fragrance into said particles.

10. A process for preparing a perfume delivery system according to claim 1, comprising the steps:
a) reacting an organosilane having at least one functional group comprising a basic nitrogen atom with an alkylating agent to obtain an organosilane having at least one functional group comprising an alkylated nitrogen atom carrying a positive charge;
b) reacting the product obtained in step a) with insoluble carrier particles having surface silanol groups to obtain carrier particles, wherein at least part of said silanol groups are substituted with organic residues carrying said functional group comprising an alkylated nitrogen atom carrying a positive charge; and
c) contacting the particles obtained in step b) with a fragrance to adsorb said fragrance onto said particles or absorb said fragrance into said particles.

11. The process of claim 9, wherein the organosilane has the formula
(R¹O)₃₋ₙR²ₙSi(CH₂)₃Z,
wherein:
R¹ and R² are independently methyl, ethyl, n-propyl or n-butyl,
n is 0 or 1,
Z is NR³R⁴, imidazolyl or 2-imidazolin-1-yl,
R³ and R⁴ are independently hydrogen, methyl, ethyl, C₃₋₂₀ alkyl, C₇₋₂₆ aralkyl,
(CH₂CH₂O)ₘR⁵ or (CH₂CH₂NH)ₘR⁵,
m is from 1 to 4, and
R⁵ is hydrogen, methyl, ethyl, C₃₋₂₀ alkyl or C₇₋₂₆ aralkyl.

12. The process of claim 9, wherein the alkylating agent is selected from the group consisting essentially of: dimethylsulfate; diethylsulfate; dimethylcarbonate; methyl chloride; methyl bromide; and benzyl chloride.

13. The process of claim 10, wherein the organosilane reacted in step a) has the formula
(R¹O)₃₋ₙR²ₙSi(CH₂)₃Z
wherein:
R¹ and R² are independently methyl, ethyl, n-propyl or n-butyl,
n is 0 or 1,
Z is NR³R⁴, imidazolyl or 2-imidazolin-1-yl,
R³ and R⁴ are independently hydrogen, methyl, ethyl, C₃₋₂₀ alkyl, C₇₋₂₆ aralkyl,
(CH₂CH₂O)ₘR⁵ or (CH₂CH₂NH)ₘR⁵,
m is from 1 to 4, and
R⁵ is hydrogen, methyl, ethyl, C₃₋₂₀ alkyl or C₇₋₂₆ aralkyl.

14. The process of claim 10, wherein the alkylating agent is selected from the group consisting essentially of: dimethylsulfate; diethylsulfate; dimethylcarbonate; methyl chloride; methyl bromide; and benzyl chloride.

15. A process for preparing a perfume delivery system according to claim 1, comprising the steps:
a) reacting water insoluble carrier particles having surface silanol groups with an organosilane having at least one functional group comprising a basic nitrogen atom or a hydroxy radical to obtain carrier particles, wherein at least part of said silanol groups are substituted with organic residues carrying said functional group;
b) reacting the particles obtained in step a) with a quaternary ammonium compound comprising an epoxy or chlorohydrin functional group to obtain carrier particles, wherein at least part of said organic residues carry at least one functional group comprising a quaternary ammonium group; and
c) contacting the particles obtained in step b) with a fragrance to adsorb said fragrance onto said particles or absorb said fragrance into said particles.

16. The process of claim 15, wherein the quaternary ammonium compound comprising an epoxy functional group is trimethyl-1-(2,3-epoxypropyl)ammonium chloride.

17. The process of claim 15, wherein the quaternary ammonium compound comprising a chlorohydrin functional group is trimethyl-1-(3-chloro-2-hydroxypropyl)-ammonium chloride.

18. A fabric softening composition, comprising a perfume delivery system according to claim 1 and one or more fabric softening active quaternary ammonium compounds.

19. The fabric softening composition of claim 18, comprising one or more fabric softening active quaternary ammonium compounds of formula (I):
R⁶₄₋ₘN⁺[(CH₂)ₙ-Q-R⁷]ₘX⁻ (I)
wherein each R⁶ is independently C₁-C₆ alkyl, C₁-C₆ hydroxyalkyl or benzyl;
R⁷ is independently hydrogen, C₁₁-C₂₂ linear alkyl, C₁₁-C₂₂ branched alkyl, C₁₁-C₂₂ linear alkenyl or C₁₁-C₂₂ branched alkenyl, with the proviso that at least one of R⁷ is not hydrogen;
Q is independently selected from the units having the formula —O—C(O)—, —C(O)O—, —NR⁸—C(O)—, —C(O)—NR⁸—, —O—C(O)—O—, —CHR⁹—O—C(O)— or —CH(OCOR⁷)—CH₂—O—C(O)—, wherein R⁸ is hydrogen, methyl, ethyl, propyl or butyl and R⁹ is hydrogen or methyl;
m is from 1 to 4;
n is from 1 to 4; and
X⁻ is a softener compatible anion.

20. The fabric softening composition of claim 19, wherein:
R⁶ is methyl; Q is —O—C(O)— or —NH—C(O)—; m is 2 or 3; n is 2; and X⁻ is chloride or methyl sulfate.

21. The fabric softening composition of claim 18, comprising one or more fabric softening active quaternary ammonium compounds selected from the group of compounds of formulae (II) to (VII): 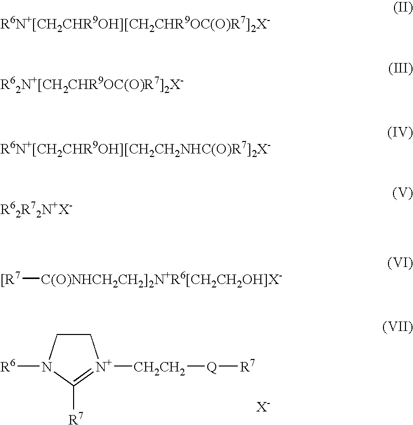
wherein each R⁶ is independently C₁-C₆ alkyl, C₁-C₆ hydroxyalkyl or benzyl;
R⁷ is independently C₁₁-C₂₂ linear alkyl, C₁₁-C₂₂ branched alkyl, C₁₁-C₂₂ linear alkenyl or C₁₁-C₂₂ branched alkenyl;
Q is —O—C(O)— or —NH—C(O)—; and
X⁻ is a softener compatible anion.

22. The fabric softening composition of claim 18, comprising from 0.1 to 5 wt % of the perfume delivery system, from 1 to 50 wt % of fabric softening active quaternary ammonium compounds and further comprising water.

23. The fabric softening composition of claim 18, comprising a mixture containing from 0.1 to 5 wt % of the perfume delivery system and from 1 to 99 wt % of fabric softening active quaternary ammonium compounds disposed on an absorbent article.

24. A laundry detergent composition, comprising a perfume delivery system according to claim 1 and one or more surfactants.
